(19) United States
(12) Patent Application Publication
(10) Pub. No.: US 2024/0190076 A1
(43) Pub. Date: Jun. 13, 2024

(54) 3D PRINTER OUTPUT POST-PROCESSING APPARATUS

(71) Applicant: ELECTRONICS AND TELECOMMUNICATIONS RESEARCH INSTITUTE, Daejeon (KR)

(72) Inventors: Chang Beom KIM, Daejeon (KR); Hyun Chul KANG, Daejeon (KR); Eun Seo LEE, Daejeon (KR); Min Gi KIM, Daejeon (KR)

(21) Appl. No.: 18/498,221

(22) Filed: Oct. 31, 2023

(30) Foreign Application Priority Data
Dec. 9, 2022 (KR) 10-2022-0172039

(51) Int. Cl. B29C 64/35; B29C 64/379; B29C 64/393; B33Y 30/00; B33Y 40/20

(52) U.S. Cl. CPC B29C 64/35; B29C 64/379; B29C 64/393; B33Y 30/00; B33Y 40/20

(57) ABSTRACT

The present invention relates to a three-dimensional (3D) printer output post-processing apparatus including at least one of a supply module configured to receive an output from 3D printers, a first cleaning module configured to clean the output, a second cleaning module configured to clean the output, and a drying and post-curing module configured to dry and solidify the output, wherein the supply module, the first cleaning module, the second cleaning module, and the drying and post-curing module are modularized so that at least one thereof is optionally combined.

### CROSS-REFERENCE TO RELATED APPLICATION

This application claims priority to and the benefit of Korean Patent Application No. 2022-0172039, filed on Dec. 9, 2022, the disclosure of which is incorporated herein by reference in its entirety.

### BACKGROUND

### 1. Field of the Invention

The present invention relates to a three-dimensional (3D) printer output post-processing apparatus, and more particularly, to a 3D printer output post-processing apparatus that consecutively and effectively performs supply, cleaning, drying, and post-curing processes to flexibly produce 3D photo-curing additive manufacturing outputs.

### 2. Description of Related Art

Three dimensional (3D) printing technologies enable items with various shapes to be rapidly and conveniently manufactured and thus are being spotlighted as the next-generation advanced manufacturing technologies.

Among them, digital light processing (DLP)-type liquid additive manufacturing equipment has a very high production speed as compared with other 3D printing types and thus is applied to manufacturing sites of finished products and parts. In DLP-type liquid additive manufacturing equipment, in order to produce actual products, post-processing processes such as cleaning, rinsing, drying, and curing processes should be performed.

Conventional post-processing processes are currently manually performed by professional workers, and parameter setting values of equipment for each process are set and controlled in detail based on experience.

In addition, in conventional post-processing processes, settings are manually adjusted according to a size, quantity, shape, and the like of a product to perform a process, and a worker manually transfers an object between processes. In addition, in conventional post-processing processes, only in-line process post-processing is possible, resulting in low production speed and low efficiency when various outputs should be quickly processed.

The related art of the present invention is disclosed in Korean Registered Patent Publication No. 10-2458144 (Oct. 19, 2022) (entitled “3D printer and 3D printing method using the same).

### SUMMARY OF THE INVENTION

The present invention is directed to providing a three-dimensional (3D) printer output post-processing apparatus that basically performs supply, cleaning, drying, and post-curing processes consecutively and effectively to flexibly produce 3D photo-curing additive manufacturing outputs.

According to an aspect of the present invention, there is provided a 3D printer output post-processing apparatus including at least one of a supply module configured to receive an output from 3D printers, a first cleaning module configured to clean the output, a second cleaning module configured to clean the output, and a drying and post-curing module configured to dry and solidify the output, wherein the supply module, the first cleaning module, the second cleaning module, and the drying and post-curing module are modularized so that at least one thereof is optionally combined.

The supply module may include a basket transfer unit configured to horizontally or vertically transfer a basket or rotate the basket, and a basket supply module configured to supply the basket to the basket transfer unit.

The basket transfer unit may include an output recognition sensor configured to recognize the output, a supply horizontal transfer system configured to horizontally transfer the basket, a supply vertical transfer system configured to vertically transfer the basket, a supply circular stage configured to horizontally rotate the basket, the supply horizontal transfer system, and the supply vertical transfer system, a supply horizontal position detector configured to detect a position of the basket in a horizontal direction, a supply vertical position detector configured to detect a position of the basket in a vertical direction, and a supply rotation position detector configured to detect a rotation position of the supply circular stage.

The first cleaning module may include a first cleaning system configured to clean the output using a first cleaning solution, and a first basket cleaning transfer unit configured to horizontally or vertically transfer the basket or rotate the basket.

The first cleaning system may include a cleaning container configured to store the first cleaning solution, a multi-nozzle system configured to generate high-pressure flow to a center from each side surface and a bottom of the cleaning container, and a first cleaning solution temperature maintenance system configured to maintain a temperature of the first cleaning solution in a first set temperature range.

The first basket cleaning transfer unit may include a first cleaning horizontal transfer system configured to horizontally transfer the basket, a first cleaning vertical transfer system configured to vertically transfer the basket, a first cleaning circular stage configured to horizontally rotate the basket, the first cleaning horizontal transfer system, and the first cleaning vertical transfer system, a first cleaning horizontal position detector configured to detect a position of the basket in a horizontal direction, a first cleaning vertical position detector configured to detect a position of the basket in a vertical direction, and a first cleaning rotation position detector configured to detect a rotation position of the first cleaning circular stage.

The second cleaning module may include a second cleaning system configured to clean the output using a second cleaning solution, and a second basket cleaning transfer unit configured to horizontally or vertically transfer a basket or rotate the basket.

The second cleaning system may include a cleaning container configured to store the second cleaning solution, a multi-nozzle system configured to generate high-pressure flow to a center from each side surface and a bottom of the cleaning container, and a second cleaning solution temperature maintenance system configured to maintain a temperature of the second cleaning solution in a second set temperature range.

The second basket cleaning transfer unit may include a second cleaning horizontal transfer system configured to horizontally transfer the basket, a second cleaning vertical transfer system configured to vertically transfer the basket, a second cleaning circular stage configured to horizontally rotate the basket, the second cleaning horizontal transfer system, and the second cleaning vertical transfer system, a second cleaning horizontal position detector configured to detect a position of the basket in a horizontal direction, a second cleaning vertical position detector configured to detect a position of the basket in a vertical direction, and a second cleaning rotation position detector configured to detect a rotation position of the second cleaning circular stage.

The drying and post-curing module may include a drying and post-curing system configured to dry and solidify the output, and a drying and post-curing transfer unit configured to horizontally or vertically transfer the basket or rotate the basket.

The drying and post-curing system may include a drying container configured to accommodate the basket, and a fan heater configured to send hot air into the drying container.

The drying and post-curing transfer unit may include a drying and post-curing horizontal transfer system configured to horizontally transfer the basket, a drying and post-curing vertical transfer system configured to vertically transfer the basket, a drying and post-curing circular stage configured to horizontally rotate the basket, the drying and post-curing horizontal transfer system, and the drying and post-curing vertical transfer system, a drying and post-curing horizontal position detector configured to detect a position of the basket in a horizontal direction, a drying and post-curing vertical position detector configured to detect a position of the basket in a vertical direction, and a drying and post-curing rotation position detector configured to detect a rotation position of the drying and post-curing circular stage.

At least one of the first cleaning module, the second cleaning module, and the drying and post-curing module may be installed in plural.

At least one of the supply module, the first cleaning module, the second cleaning module, and the drying and post-curing module may be connected in at least one direction.

The supply module may be optionally connected to at least one of the 3D printers to receive the output from any one of the printers.

According to an aspect of the present invention, there is provided a 3D printer output post-processing apparatus including a supply module configured to receive an output manufactured by 3D printers, a first cleaning module configured to receive the output from the supply module and clean the output, a second cleaning module configured to clean the output cleaned in the first cleaning module, and a drying and post-curing module configured to dry and solidify the output cleaned in the second cleaning module.

The supply module may include a basket transfer module configured to supply a basket configured to receive and transfer the output, and a basket supply unit configured to horizontally or vertically transfer the basket or rotate the basket.

The first cleaning module may include a first cleaning system configured to clean the output using a first cleaning solution, and a first basket cleaning transfer unit configured to horizontally or vertically transfer a basket or rotate the basket.

The second cleaning module may include a second cleaning system configured to clean the output using a second cleaning solution, and a second basket cleaning transfer unit configured to horizontally or vertically transfer a basket or rotate the basket.

The drying and post-curing module may include a drying and post-curing system configured to dry and solidify the output, and a drying and post-curing transfer unit configured to horizontally or vertically transfer a basket or rotate the basket.

### BRIEF DESCRIPTION OF THE DRAWINGS

FIG. 1 is a conceptual view of a three-dimensional (3D) printer output post-processing apparatus according to one embodiment of the present invention.

FIG. 2 is a side view of the 3D printer output post-processing apparatus according to one embodiment of the present invention.

FIG. 3 is a plan view of the 3D printer output post-processing apparatus according to one embodiment of the present invention.

FIG. 4 is a conceptual view of a supply module according to one embodiment of the present invention.

FIG. 5 is a front view of the supply module according to one embodiment of the present invention.

FIG. 6 is a side view of the supply module according to one embodiment of the present invention.

FIG. 7 is a plan view of the supply module according to one embodiment of the present invention.

FIG. 8 is a conceptual view of a first cleaning module according to one embodiment of the present invention.

FIG. 9 is a front view of the first cleaning module according to one embodiment of the present invention.

FIG. 10 is a side view of the first cleaning module according to one embodiment of the present invention.

FIG. 11 is a plan view of the first cleaning module according to one embodiment of the present invention.

FIG. 12 is a conceptual view of a second cleaning module according to one embodiment of the present invention.

FIG. 13 is a front view of the second cleaning module according to one embodiment of the present invention.

FIG. 14 is a side view of the second cleaning module according to one embodiment of the present invention.

FIG. 15 is a plan view of the second cleaning module according to one embodiment of the present invention.

FIG. 16 is a conceptual view of a drying and post-curing module according to one embodiment of the present invention.

FIG. 17 is a front view of the drying and post-curing module according to one embodiment of the present invention.

FIG. 18 is a side view of the drying and post-curing module according to one embodiment of the present invention.

FIG. 19 is a plan view of the drying and post-curing module according to one embodiment of the present invention.

FIG. 20 is a view illustrating an example of an arrangement method of a 3D printer output post-processing apparatus according to one embodiment of the present invention.

FIG. 21 is a side view of the 3D printer output post-processing apparatus shown in FIG. 20.

FIG. 22 is a plan view of the 3D printer output post-processing apparatus shown in FIG. 20.

FIG. 23 is a view illustrating another example of an arrangement method of a 3D printer output post-processing apparatus according to one embodiment of the present invention.

FIG. 24 is a view illustrating still another example of an arrangement method of a 3D printer output post-processing apparatus according to one embodiment of the present invention.

FIG. 25 is a view illustrating yet another example of an arrangement method of a 3D printer output post-processing apparatus according to one embodiment of the present invention.

FIG. 26 is a side view of the 3D printer output post-processing apparatus shown in FIG. 25.

FIG. 27 is a plan view of the 3D printer output post-processing apparatus shown in FIG. 25.

### DETAILED DESCRIPTION OF EXEMPLARY EMBODIMENTS

Hereinafter, examples of a three-dimensional (3D) printer output post-processing apparatus according to one embodiment of the present invention will be described. In a process, thicknesses of lines or sizes of components shown in the drawings may be exaggerated for the sake of convenience and clarity in description. Furthermore, terminologies used herein are defined by taking functions of the present invention into account and may be changed according to a custom or the intent of a user or an operator. Accordingly, the terminologies should be defined based on the following overall description of the present specification.

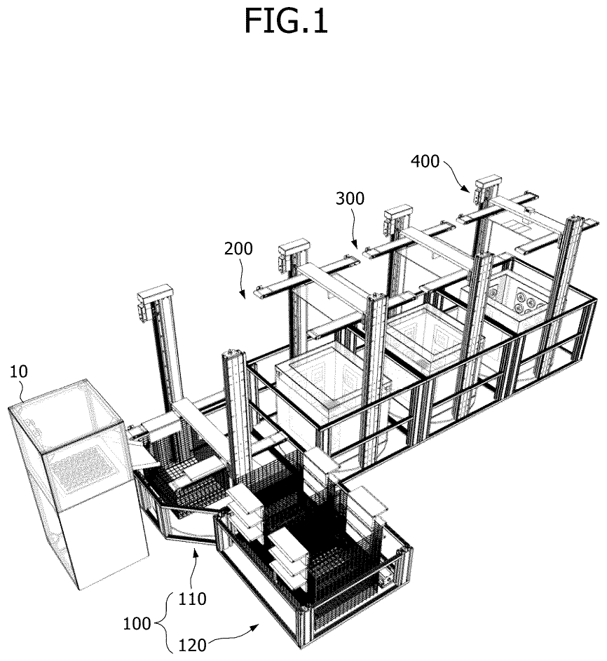

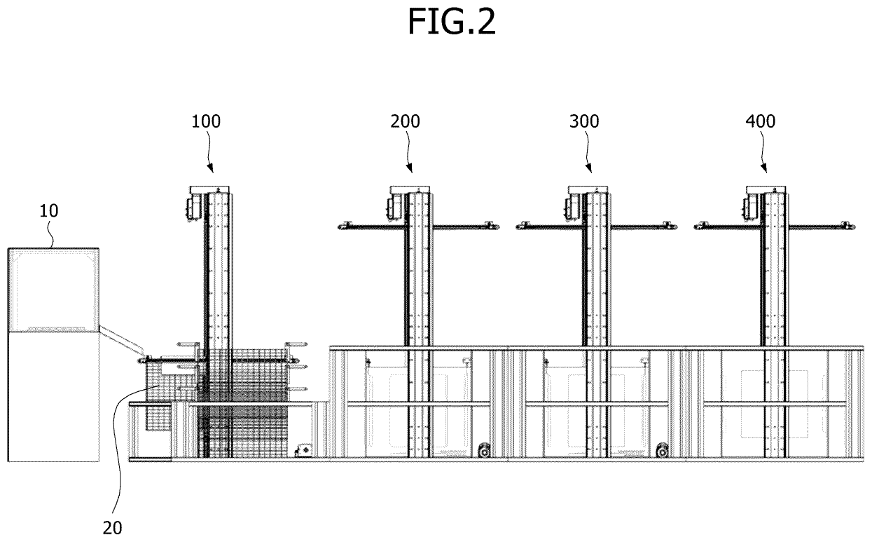

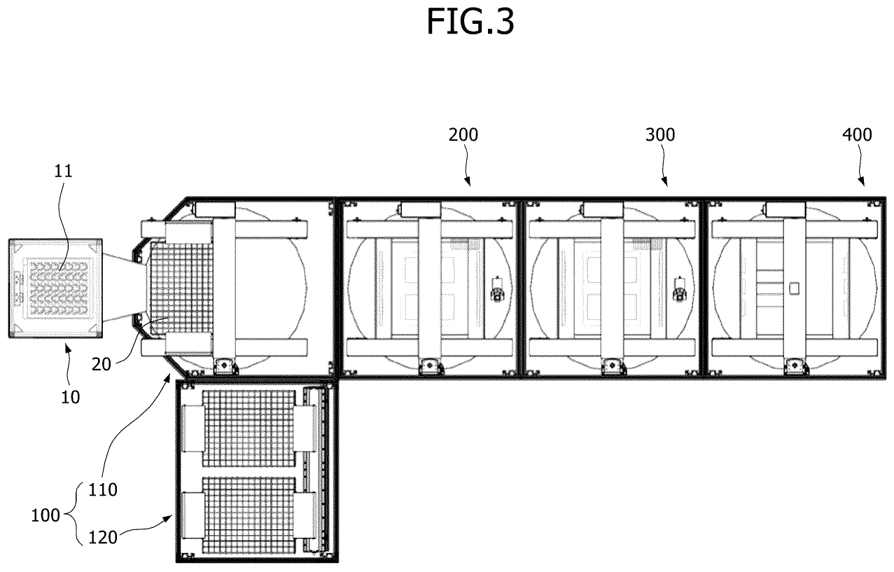

FIG. 1 is a conceptual view of a 3D printer output post-processing apparatus according to one embodiment of the present invention. FIG. 2 is a side view of the 3D printer output post-processing apparatus according to one embodiment of the present invention. FIG. 3 is a plan view of the 3D printer output post-processing apparatus according to one embodiment of the present invention.

Referring to FIGS. 1 to 3, the 3D printer output post-processing apparatus according to one embodiment of the present invention includes a supply module 100, a first cleaning module 200, a second cleaning module 300, and a drying and post-curing module 400.

In FIGS. 1 to 3, the supply module 100, the first cleaning module 200, the second cleaning module 300, and the drying and post-curing module 400 are illustrated as being consecutively disposed.

However, each process module such as the supply module 100, the first cleaning module 200, the second cleaning module 300, or the drying and post-curing module 400 may be modularized, independently separated, and individually operated.

At least one of the supply module 100, the first cleaning module 200, the second cleaning module 300, and the drying and post-curing module 400 may be added or excluded and may be optionally connected to the same or different process module.

The supply module 100 may supply an output to at least one of the first cleaning module 200, the second cleaning module 300, and the drying and post-curing module 400. Accordingly, not only a combination of a single 3D printer 10 and post-processing process modules, but also a combination of a plurality of 3D printers 10 and a plurality of process modules may be implemented. In this case, the plurality of 3D printers 10 and the plurality of process modules may be combined, and here, timings of different outputs individually produced by the plurality of 3D printers 10 may be adjusted for flexible post-processing.

This will be described below.

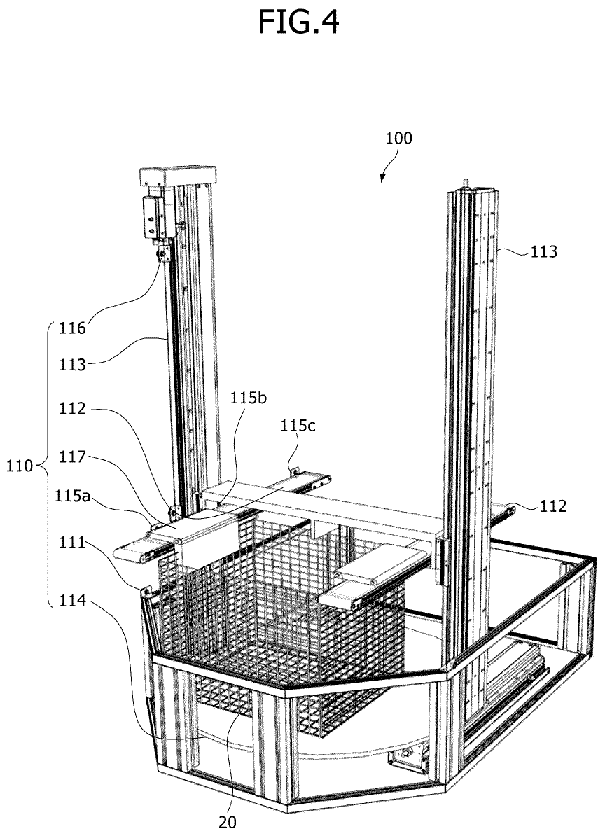

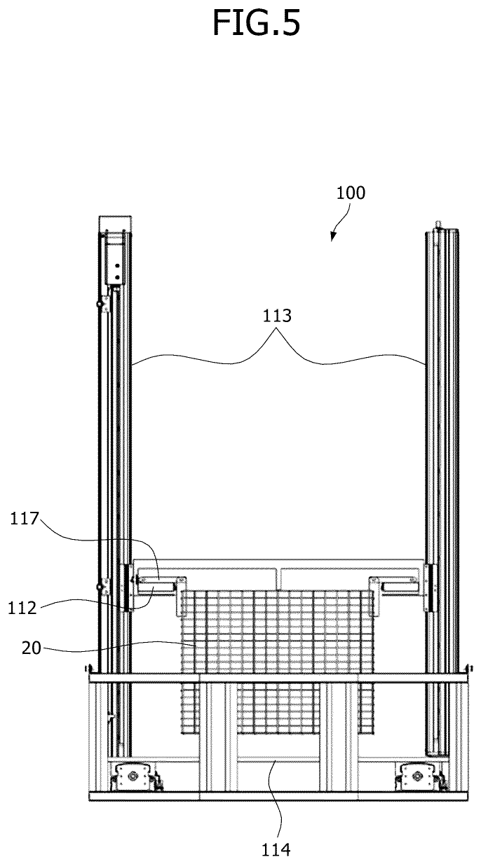

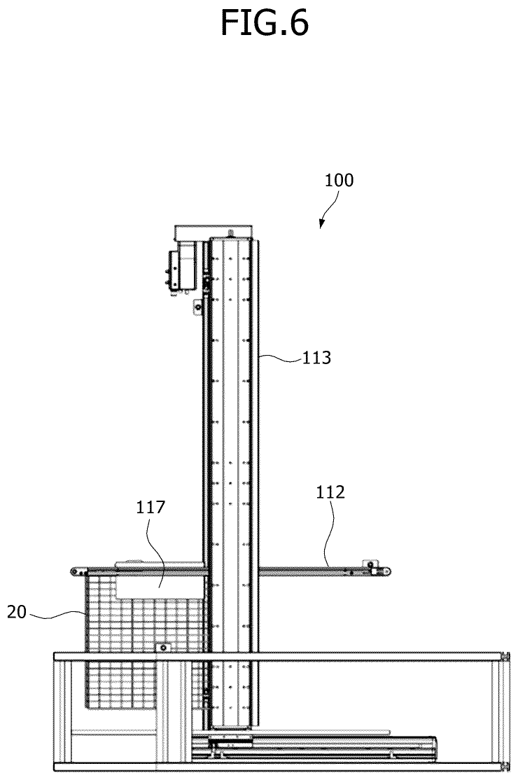

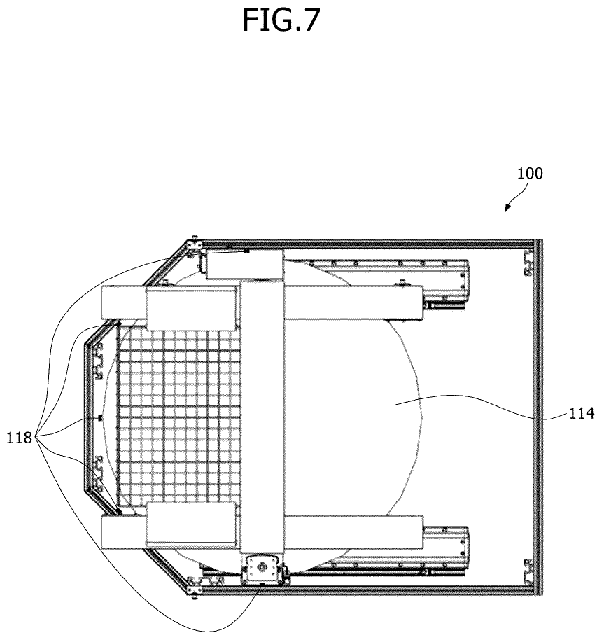

FIG. 4 is a conceptual view of a supply module according to one embodiment of the present invention. FIG. 5 is a front view of the supply module according to one embodiment of the present invention. FIG. 6 is a side view of the supply module according to one embodiment of the present invention. FIG. 7 is a plan view of the supply module according to one embodiment of the present invention.

Referring to FIGS. 4 to 7, first, the supply module 100 receives an output from the 3D printer 10.

The supply module 100 receives the output manufactured by the 3D printer 10 and transfers the output to a process module in a subsequent operation. The process module in a subsequent operation may be any one of the first cleaning module 200, the second cleaning module 300, and the drying and post-curing module 400.

The supply module 100 includes a basket transfer unit 110 and a basket supply module 120.

The basket supply module 120 supplies a basket 20 to the basket transfer unit 110. The basket supply module 120 may be installed on a side surface of the basket transfer module 110.

The basket transfer unit 110 transfers the basket 20 accommodating an output to the process module in a subsequent operation.

The basket transfer unit 110 may be connected to the plurality of 3D printers 10 at the same time. In this case, according to individual manufacturing progress, the basket transfer module 110 may receive the basket 20 from any one of the 3D printers 10 to transfer the basket 20 to the process module in a subsequent operation.

The basket 20 is a structure with a wire mesh configuration for transferring collective outputs output from the 3D printers 10 to each process module without loss.

The basket transfer unit 110 horizontally or vertically transfers the basket 20 or rotates the basket 20.

The basket transfer unit 110 includes an output recognition sensor 111, a supply horizontal transfer system 112, a supply vertical transfer system 113, a supply circular stage 114, a supply horizontal position detector 115, a supply vertical position detector 116, and a supply rotation position detector 118.

The output recognition sensor 111 recognizes an output.

The supply horizontal transfer system 112 horizontally transfers the basket 20.

The supply horizontal transfer system 112 may include any type of compact transfer system that may be mounted within a range of an individual module such as a conveyor, a rail, or a linear stage.

The supply horizontal transfer system 112 may be formed in a hexagonal shape to connect the maximum number of 3D printers 10 to the supply module 100.

The supply vertical transfer system 113 vertically transports the basket 20 and the conveyor.

The supply circular stage 114 horizontally rotates the basket 20, the supply horizontal transfer system 112, and the supply vertical transfer system 113.

The supply circular stage 114 may rotate the basket 20, the supply horizontal transfer system 112, and the supply vertical transfer system 113 360 degrees.

The supply horizontal position detector 115 detects the position of the basket 20 in a horizontal direction. The supply horizontal position detector 115 includes a first supply horizontal position sensor 115a installed at one end portion of the supply horizontal transfer system 112 to detect the position of the basket 20, a third supply horizontal position sensor 115c installed at the other end portion of the supply horizontal transfer system 112 to detect the position of the basket 20, and a second supply horizontal position sensor 115b installed at a central portion of the supply horizontal transfer system 112 to detect the position of the basket 20.

The number and installation positions of sensors of the supply horizontal position detector 115 are not particularly limited.

The supply vertical position detector 116 detects the position of the basket 20 in a vertical direction. The supply vertical position detector 116 includes a first supply vertical position sensor 116a installed at one end portion of the supply vertical transfer system 113 to detect the basket 20, and a second supply vertical position sensor 116b installed at the other end portion of the supply vertical transfer system 113 to detect the basket 20.

The number and installation positions of sensors of the supply vertical position detector 116 are not particularly limited.

The supply rotation position detector 118 detects the rotation position of the supply circular stage 114. A plurality of supply rotation position detectors 118 may be provided and installed at positions of the supply circular stage 114 at each of 0 degrees, 45 degrees, 90 degrees, 270 degrees, and 350 degrees. The installation positions, angles, and number of the supply rotation position detectors 118 are not particularly limited. FIG. 7 illustrates the installation positions of the supply rotation position detectors 118.

Meanwhile, the basket 20 may be equipped with a basket hanger 117 having a “¬” shape to be placed on an upper end of the supply horizontal transfer system 112.

The length of the basket hanger 117 is relatively longer than an interval between process modules. That is, since the length of the basket hanger 117 is formed longer than an interval between the supply horizontal transfer system 112 and a first cleaning horizontal transfer system 212, an interval between the first cleaning horizontal transfer system 212 and a second cleaning horizontal transfer system 312, an interval between the second cleaning horizontal transfer system 312 and a drying and post-curing horizontal transfer system 412, an interval between the supply horizontal transfer system 112 and the second cleaning horizontal transfer system 312, and an interval between the supply horizontal transfer system 112 and the drying and post-curing horizontal transfer system 412, the basket 20 may be transferred between the process modules.

In addition, the supply module 100 includes a rotation device (not shown) to pour an output into a collection container after a post-curing process of a final operation.

A process of transferring the basket 20 from the supply module 100 to the first cleaning module 200 is as follows.

The output recognition sensor 111 recognizes an output falling (being supplied) from the 3D printer 10 to the basket 20. The output recognition sensor 111 turns off when the supply of the output to the basket 20 is completed.

When the supply horizontal transfer system 112 transfers the basket 20, the first supply horizontal position sensor 115a turns off, and a second supply horizontal position sensor 115b recognizes the basket 20. In this case, the supply horizontal transfer system 112 stops.

While the supply vertical transfer system 113 vertically lifts and transfers the basket 20, the second supply vertical position sensor 116b turns off, and the first supply horizontal position sensor 115a recognizes the basket 20. In this case, the supply vertical transfer system 113 stops.

Additionally, when the supply horizontal transfer system 112 further transfers the basket 20, the second supply horizontal position sensor 115b turns off, and the third supply horizontal position sensor 115c recognizes the basket 20. In this case, the supply horizontal transfer system 112 temporarily stops.

Before the basket 20 is transferred to the first cleaning module 200 that is a subsequent process module, it is checked whether the supply horizontal transport system 112 of the first cleaning module 200 is arranged in parallel in a line.

To this end, when a first cleaning rotation position detector 218 of the first cleaning module 200 is turned on, the supply horizontal transfer system 112 of the supply module 100 reoperates to transfer the basket 20 to the supply horizontal transfer system 112 of the first cleaning module 200. In such a process, the third supply horizontal position sensor 115c of the supply module 100 is turned off, and a 1-1 cleaning horizontal position sensor 215a of the first cleaning module 200 is turned on. Accordingly, the first cleaning horizontal transfer system 212 of the first cleaning module 200 starts to operate and pull the basket 20.

When an orientation of the first cleaning module 200 is rotated (90 degrees or 270 degrees), a first cleaning circular stage 214 operates to be arranged with the supply horizontal transfer system 112 of the supply module 100 in a line.

The supply module 100 returns to an initial mode when the second supply horizontal position sensor 115b is turned off after the basket 20 is completely transferred, and then, in order to receive the empty basket 20, the supply horizontal transfer system 112 lowers and interworks with the basket supply module 120.

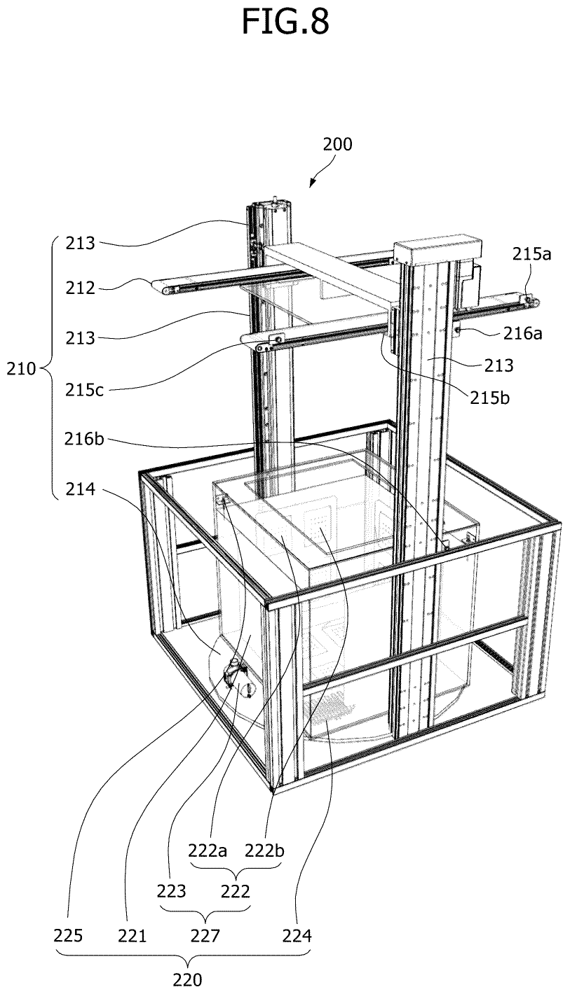

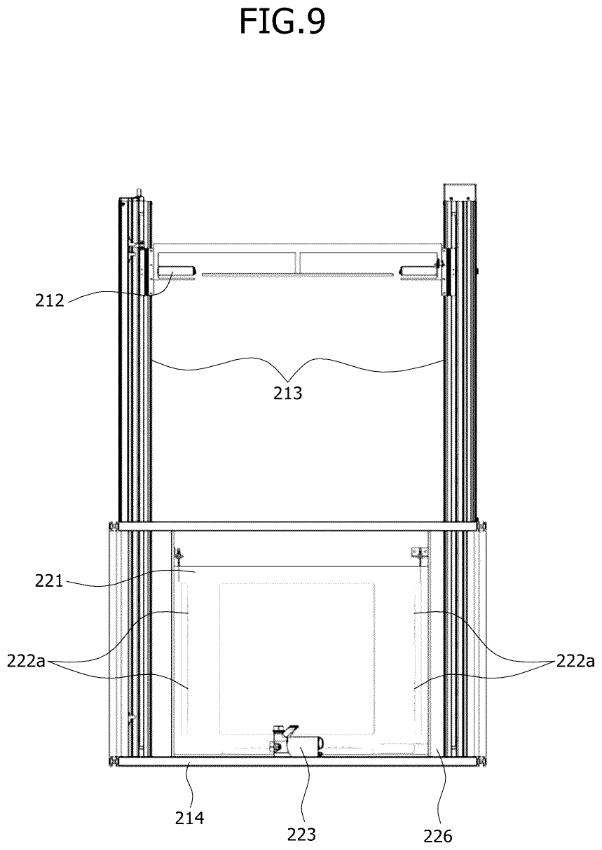

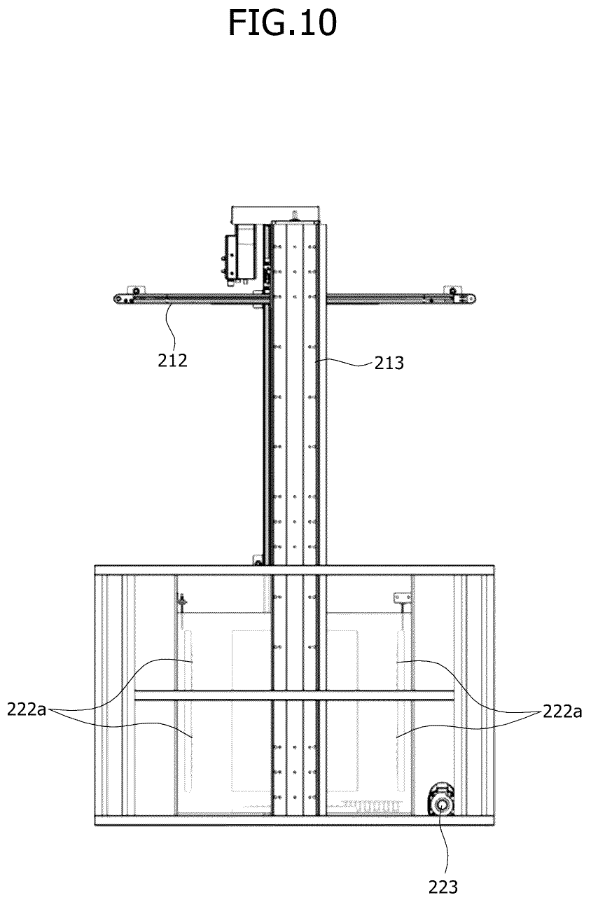

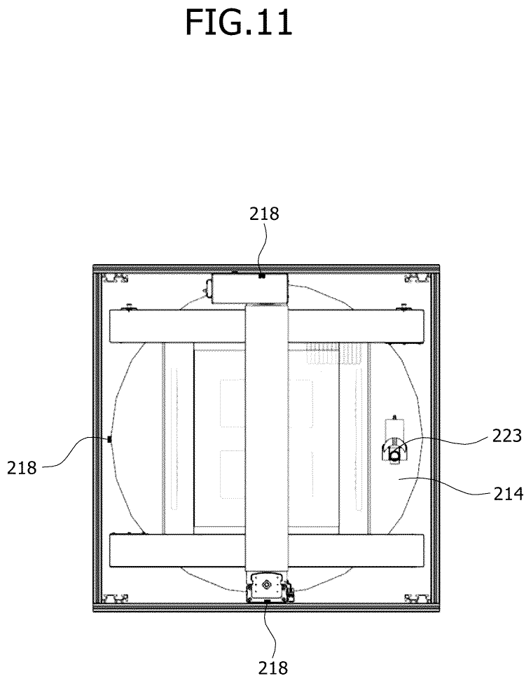

FIG. 8 is a conceptual view of a first cleaning module according to one embodiment of the present invention. FIG. 9 is a front view of the first cleaning module according to one embodiment of the present invention. FIG. 10 is a side view of the first cleaning module according to one embodiment of the present invention. FIG. 11 is a plan view of the first cleaning module according to one embodiment of the present invention.

Referring to FIGS. 8 to 11, the first cleaning module 200 cleans an output using a first cleaning solution.

The first cleaning module 200 includes a first basket cleaning transfer unit 210 and a first cleaning system 220.

The first cleaning system 220 includes a first cleaning container 221, a first cleaning unit 227, and a first cleaning solution temperature maintenance system 224.

The first cleaning container 221 stores the first cleaning solution.

The first cleaning unit 227 generates high-pressure flow to the center from each side surface and a bottom of the first cleaning container 221 to clean an output.

The first cleaning unit 227 includes a first multi-nozzle system 222, a first pump system 223, a drainage system (not shown) for exchanging the first cleaning solution, and a first cover (not shown).

The first multi-nozzle system 222 generates high-pressure flow in a direction from each side surface and the bottom toward the center of the first cleaning container 221.

The first multi-nozzle system 222 divides each side surface of the first cleaning container 221 into four quadrants, and the quadrants each operate independently to repeatedly control a flow direction in a clockwise or counterclockwise direction and a vertical direction to perform a cleaning function as effectively as possible.

The first pump system 223 circulates the first cleaning solution.

The drainage system (not shown) for exchanging the first cleaning solution drains and replaces the first cleaning solution that is contaminated due to long-time use.

The first cleaning solution temperature maintenance system 224 detects the temperature of the first cleaning solution through the first cleaning solution temperature sensor 225 and maintains the temperature of the first cleaning solution in a preset first cleaning solution temperature range according to the detected temperature of the first cleaning solution.

The first basket cleaning transfer unit 210 horizontally or vertically transfers the basket 20 or rotates the basket 20.

The first cover prevents the first cleaning solution from leaking to the outside when the first cleaning unit 227 operates.

The first basket cleaning transfer unit 210 includes the first cleaning horizontal transfer system 212, a first cleaning vertical transfer system 213, the first cleaning circular stage 214, a first cleaning horizontal position detector 215, a first cleaning vertical position detector 216, and a first cleaning rotation position detector 218.

The first cleaning horizontal transfer system 212 horizontally transfers the basket 20. The first cleaning horizontal transfer system 212 may include any type of compact transfer system that may be mounted within a range of an individual module such as a conveyor, a rail, or a linear stage.

The first cleaning vertical transfer system 213 vertically transports the basket 20 and the conveyor.

The first cleaning circular stage 214 horizontally rotates the basket 20, the first cleaning horizontal transfer system 212, and the first cleaning vertical transfer system 213. The first cleaning circular stage 214 may rotate the basket 20, the first cleaning horizontal transfer system 212, and the first cleaning vertical transfer system 213 360 degrees.

The first cleaning horizontal position detector 215 detects the position of the basket 20 in a horizontal direction. The first cleaning horizontal position detector 215 includes the 1-1 cleaning horizontal position sensor 215a installed at one end portion of the first cleaning horizontal transfer system 212 to detect the position of the basket 20, a 1-3 cleaning horizontal position sensor 215c installed at the other end portion of the first cleaning horizontal transfer system 212 to detect the position of the basket 20, and a 1-2 cleaning horizontal position sensor 215b installed at a central portion of the first cleaning horizontal transfer system 212 to detect the position of the basket 20.

The number and installation positions of sensors of the first cleaning horizontal position detector 215 are not particularly limited.

The first cleaning vertical position detector 216 detects the position of the basket 20 in a vertical direction. The first cleaning vertical position detector 216 includes a 1-1 cleaning vertical position sensor 216a installed at one end portion of the first cleaning vertical transfer system 213 to detect the basket 20, and a 1-2 cleaning vertical position sensor 216b installed at the other end portion of the first cleaning vertical transfer system 213 to detect the basket 20

The number and installation positions of sensors of the first cleaning vertical position detector 216 are not particularly limited.

The first cleaning rotation position detector 218 detects the rotation position of the first cleaning circular stage 214. For example, the first cleaning rotation position detector 218 is installed in the circular stage at each of angles of 0 degrees, 45 degrees, 90 degrees, 270 degrees, and 350 degrees to detect the first cleaning circular stage 214. The installation positions, angles, and number of sensors of the first cleaning rotation position detector 218 are not particularly limited.

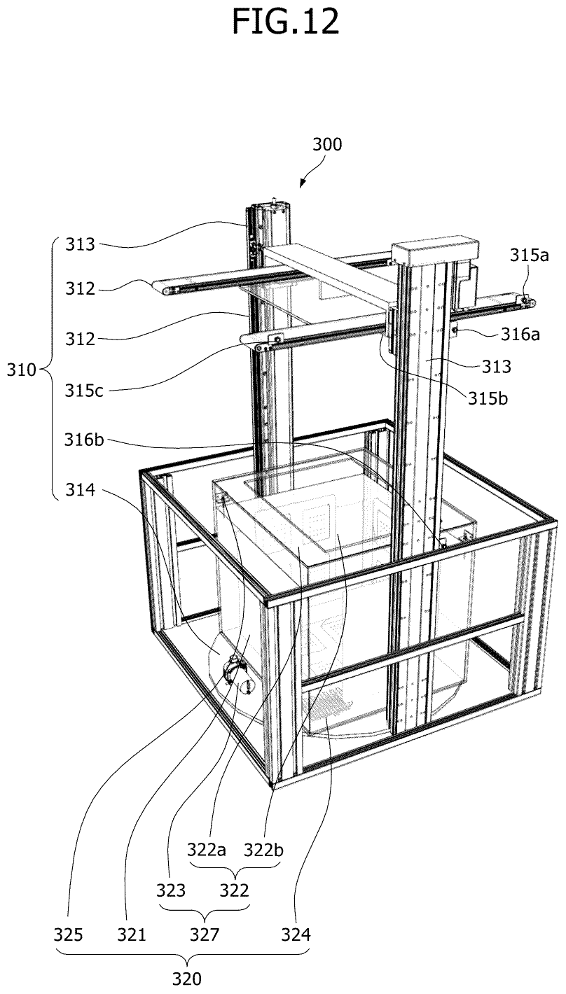

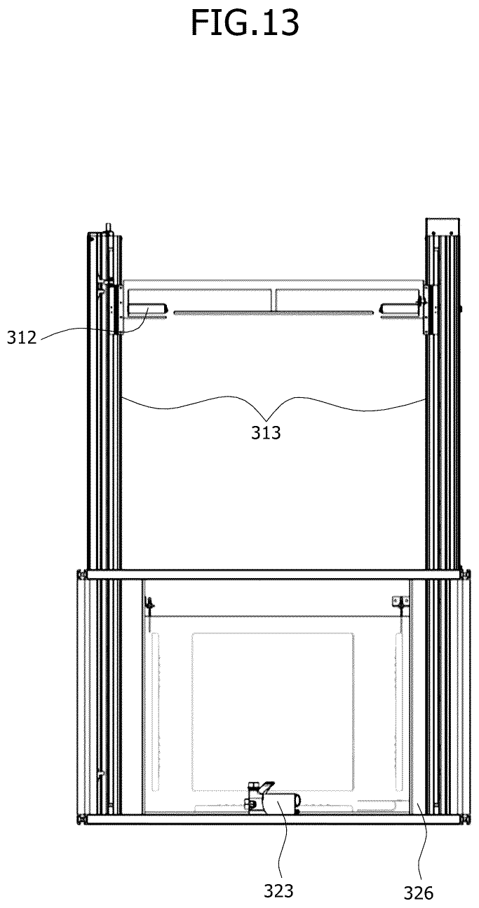

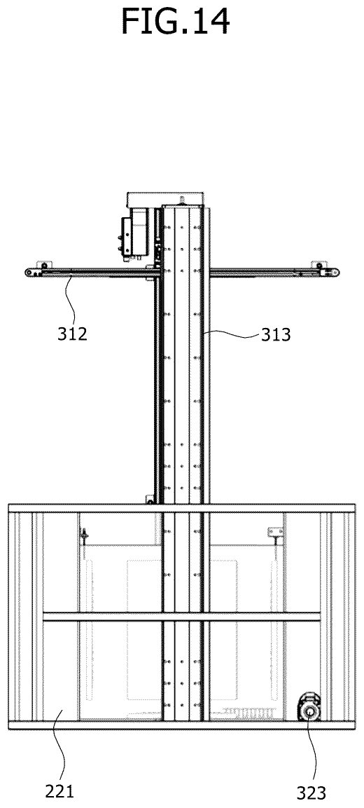

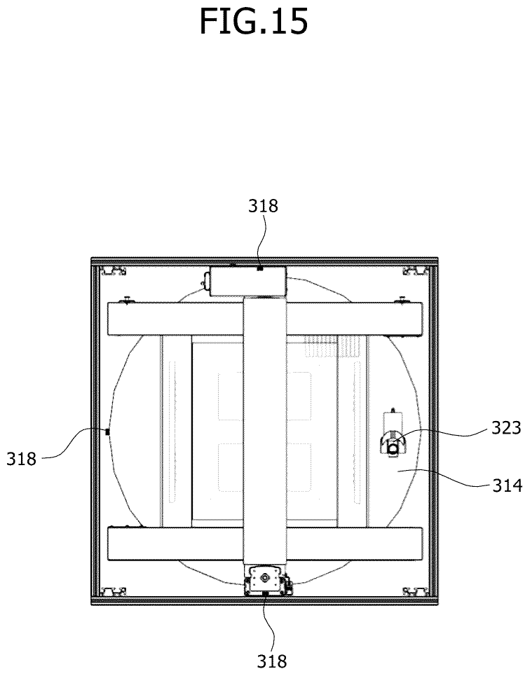

FIG. 12 is a conceptual view of a second cleaning module according to one embodiment of the present invention. FIG. 13 is a front view of the second cleaning module according to one embodiment of the present invention. FIG. 14 is a side view of the second cleaning module according to one embodiment of the present invention. FIG. 15 is a plan view of the second cleaning module according to one embodiment of the present invention.

Referring to FIGS. 12 to 15, the second cleaning module 300 cleans an output using a second cleaning solution.

The second cleaning module 300 cleans the output using the second cleaning solution.

The second cleaning module 300 includes a second basket cleaning transfer unit 310 and a second cleaning system 320.

The second cleaning system 320 includes a second cleaning container 321, a second cleaning unit 327, and a second cleaning solution temperature maintenance system 324.

The second cleaning container 321 stores the second cleaning solution.

The second cleaning unit 327 generates high-pressure flow to the center from each side surface and a bottom of the second cleaning container 321 to clean an output.

The second cleaning unit 327 includes a second multi-nozzle system 322, a second pump system 323, a drainage system (not shown) for exchanging the second cleaning solution, and a second cover (not shown).

The second multi-nozzle system 322 generate high-pressure flow in a direction from each side surface and the bottom toward the center of the second cleaning container 321.

The second multi-nozzle system 322 divides each side surface of the second cleaning container 321 into four quadrants, and the quadrants each operate independently to repeatedly control a flow direction in a clockwise or counterclockwise direction and a vertical direction to perform a cleaning function as effectively as possible.

The second pump system 323 circulates the second cleaning solution.

The drainage system (not shown) for exchanging the second cleaning solution drains and replaces the second cleaning solution that is contaminated due to long-time use.

The second cleaning solution temperature maintenance system 324 detects the temperature of the second cleaning solution through a second cleaning solution temperature sensor 325 and maintains the temperature of the second cleaning solution in a preset second cleaning solution temperature range according to the detected temperature of the second cleaning solution.

The second basket cleaning transfer unit 310 horizontally or vertically transfers the basket 20 or rotates the basket 20.

The second cover prevents the second cleaning solution from leaking to the outside when the second cleaning unit 327 operates.

The second basket cleaning transfer unit 310 includes the second cleaning horizontal transfer system 312, a second cleaning vertical transfer system 313, a second cleaning circular stage 314, a second cleaning horizontal position detector 315, a second cleaning vertical position detector 316, and a second cleaning rotation position detector 318.

The second cleaning horizontal transfer system 312 horizontally transfers the basket 20. The second cleaning horizontal transfer system 312 may include any type of compact transfer system that may be mounted within a range of an individual module such as a conveyor, a rail, or a linear stage.

The second cleaning vertical transfer system 313 vertically transports the basket 20 and the conveyor.

The second cleaning circular stage 314 horizontally rotates the basket 20, the second cleaning horizontal transfer system 312, and the second cleaning vertical transfer system 313. The second cleaning circular stage 314 may rotate the basket 20, the second cleaning horizontal transfer system 312, and the second cleaning vertical transfer system 313 360 degrees.

The second cleaning horizontal position detector 315 detects the position of the basket 20 in a horizontal direction. The second cleaning horizontal position detector 315 includes a 2-1 cleaning horizontal position sensor 315a installed at one end portion of the second cleaning horizontal transfer system 312 to detect the position of the basket 20, a 2-3 cleaning horizontal position sensor 315c installed at the other end portion of the second cleaning horizontal transfer system 312 to detect the position of the basket 20, and a 2-2 cleaning horizontal position sensor 315b installed at a central portion of the second cleaning horizontal transfer system 312 to detect the position of the basket 20.

The number and installation positions of sensors of the second cleaning horizontal position detector 315 are not particularly limited.

The second cleaning vertical position detector 316 detects the position of the basket 20 in a vertical direction. The second cleaning vertical position detector 316 includes a 2-1 cleaning vertical position sensor 316a installed at one end portion of the second cleaning vertical transfer system 313 to detect the basket 20, and a 2-2 cleaning vertical position sensor 316b installed at the other end portion of the second cleaning vertical transfer system 313 to detect the basket 20.

The number and installation positions of sensors of the second cleaning vertical position detector 316 are not particularly limited.

The second cleaning rotation position detector 318 detects the rotation position of the second cleaning circular stage 314. For example, the second cleaning rotation position detector 318 is installed in the circular stage at each of angles of 0 degrees, 45 degrees, 90 degrees, 270 degrees, and 350 degrees to detect the second cleaning circular stage 314. The installation positions, angles, and number of sensors of the second cleaning rotation position detector 318 are not particularly limited.

A process in which the first cleaning module 200 and the second cleaning module 300 receive and clean an output will be described.

When the 1-1 cleaning horizontal position sensor 215a recognizes the basket 20 transferred from the supply module 100, the first cleaning horizontal transfer system 212 operates.

When the first cleaning horizontal transfer system 212 transfers the basket 20, the 1-1 cleaning horizontal position sensor 215a turns off, and the 1-2 cleaning horizontal position sensor 215b recognizes the basket 20. In this case, the first cleaning horizontal transfer system 212 stops.

While the first cleaning vertical transfer system 213 vertically lowers and transfers the basket 20, the 1-1 cleaning vertical position sensor 216a is turned off, and when the 1-2 cleaning horizontal position sensor 215b recognizes the basket 20, the first cleaning vertical transfer system 213 stops. In this case, the basket 20 containing an output is positioned in the first cleaning solution, and while the first pump system 223 operates, the high-pressure first cleaning solution cleans the output through the multi-nozzle system 222.

In this case, a 1-1 nozzle system 222a and a 1-2 nozzle system 222b of the multi-nozzle system 222 are alternately opened or closed so that a flow direction of the first cleaning solution is alternated between clockwise and counterclockwise.

Alternatively, upper and lower portions of the 1-1 nozzle system 222a and the 1-2 nozzle system 222b are alternately opened or closed so that the flow direction of the first cleaning solution is alternated between clockwise and counterclockwise.

By adjusting revolutions per minute (RPM) of the first pump system 223 and at least one of the number of opening and closing times of the nozzles and an opening or closing time of the multi-nozzle system 222, outputs having various sizes (or volumes) can be effectively cleaned.

When the cleaning by the first cleaning module 200 is completed, the first cleaning vertical transfer system 213 vertically lifts and transfers the basket 20 so that the 1-2 cleaning vertical position sensor 216b is turned off, and the 1-1 cleaning horizontal position sensor 215a recognizes the basket 20. In this case, the first cleaning vertical transfer system 213 stops.

Additionally, while the first cleaning horizontal transfer system 212 further transfers the basket 20, the 1-2 cleaning horizontal position sensor 215b turns off, and the 1-3 cleaning horizontal position sensor 215c recognizes the basket 20. In this case, the first cleaning horizontal transfer system 212 temporarily stops.

Before the basket 20 is transferred to the second cleaning module 300 that is a subsequent process module, it is checked whether the second cleaning horizontal transfer system 312 of the second cleaning module 300 is arranged in parallel in a line.

When the second cleaning rotation position detector 318 at a position of the second cleaning module 300 at 0 degrees is turned on, the first cleaning horizontal transfer system 212 of the first cleaning module 200 reoperates to transfer the basket 20 to the second cleaning horizontal transfer system 312 of the second cleaning module 300.

In this case, the 1-3 cleaning horizontal position sensor 215c of the first cleaning module 200 is turned off, and the 2-1 cleaning horizontal position sensor 315a of the second cleaning module 300 is turned on. In this case, the second cleaning horizontal transfer system 312 of the second cleaning module 300 starts to operate and pull the basket 20. When an orientation of the second cleaning module 300 is rotated (90 degrees or 270 degrees), the second cleaning circular stage 314 operates to arrange the second cleaning horizontal transfer system 312 with the first cleaning horizontal transfer system 212 of the first cleaning module 200 in a line.

When the 1-3 cleaning horizontal position sensor 215c is turned off after the first cleaning module 200 completely transfers the basket 20, the first cleaning module 200 returns to an initial mode, and the first cleaning horizontal transfer system 212 lowers to seal the first cleaning container 221 with the first cover to prevent the evaporation of the first cleaning solution.

The operation sequence of the second cleaning module 300 is the same as that of the first cleaning module 200. Here, the detailed description thereof is omitted.

When second cleaning is completed by the second cleaning module 300, the basket 20 reaches the end of the second cleaning horizontal transfer system 312, and the 2-3 cleaning horizontal position sensor 315c recognizes the basket 20, the second cleaning horizontal transfer system 312 temporarily stops. Similarly, before the basket 20 is transferred to the drying and post-curing module 400 which is a subsequent process module, it is checked whether the drying and post-curing horizontal transfer system 412 of the post-drying and post-curing module 400 is aligned in parallel in a line.

When a drying and post-curing rotation position detector 418 at a position of the drying and post-curing module 400 at 0 degrees is turned on, the second cleaning horizontal transfer system 312 of the second cleaning module 300 reoperates to transfer the basket 20 to the drying and post-curing horizontal transfer system 412 of the post-drying and post-curing module 400.

In this case, the 2-3 cleaning horizontal position sensor 312c of the second cleaning module 300 is turned off, a drying and post-curing horizontal position detector 415 of the drying and post-curing module 400 is turned on, and a drying and post-curing horizontal transfer system 410 of the drying and post-curing module 400 starts to operate and pull the basket 20.

When an orientation of the drying and post-curing module 400 is rotated (90 degrees or 270 degrees), a drying and post-curing circular stage 414 operates to arrange the drying and post-curing horizontal transfer system 410 with the second cleaning horizontal transfer system 312 of the second cleaning module 300 in a line.

When the 2-3 cleaning horizontal position sensor 315c is turned off after the second cleaning module 300 completely transfers the basket 20, the second cleaning module 300 returns to an initial mode, and the second cleaning horizontal transfer system 312 lowers to seal the second cleaning container 321 with the second cover to prevent the evaporation of the second cleaning solution.

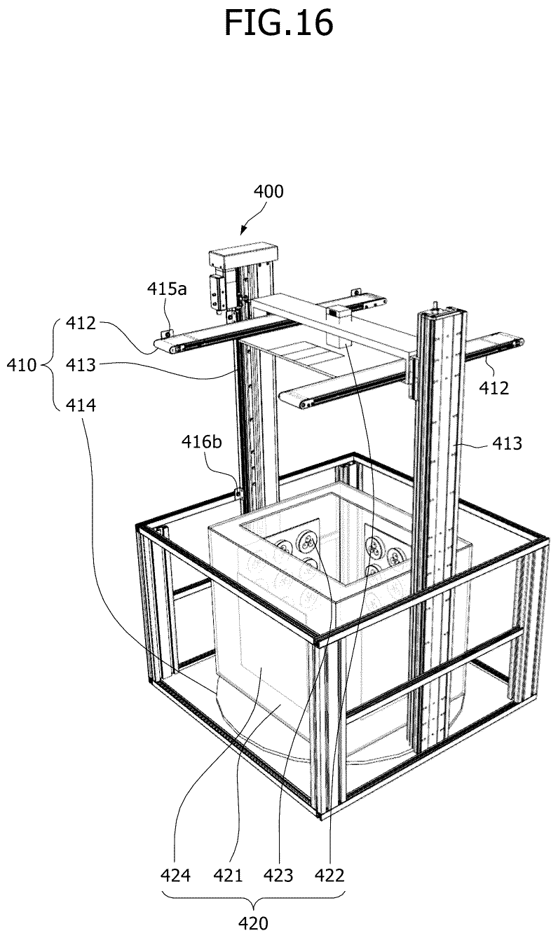

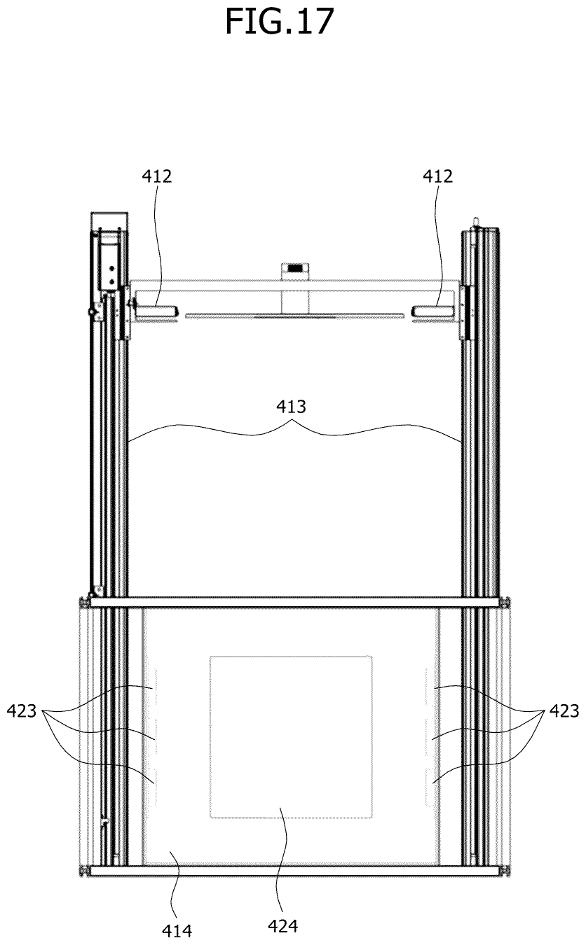

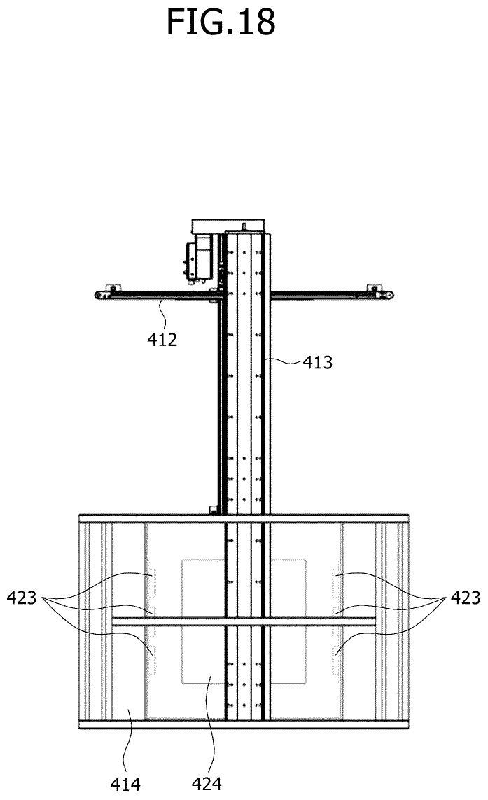

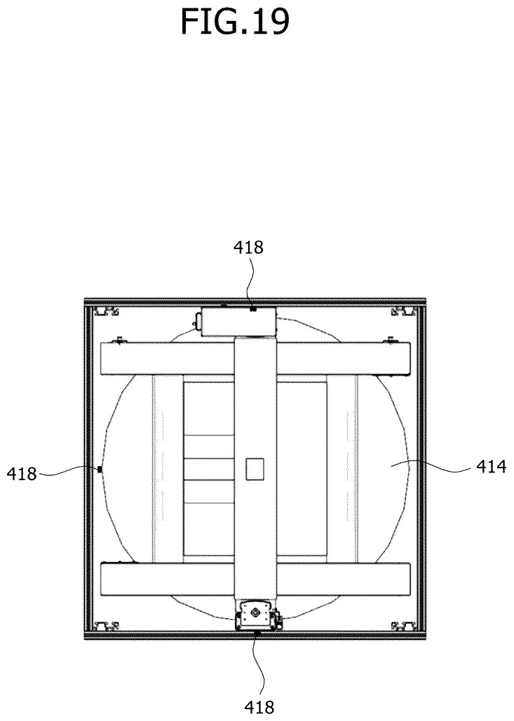

FIG. 16 is a conceptual view of a drying and post-curing module according to one embodiment of the present invention. FIG. 17 is a front view of the drying and post-curing module according to one embodiment of the present invention. FIG. 18 is a side view of the drying and post-curing module according to one embodiment of the present invention. FIG. 19 is a plan view of the drying and post-curing module according to one embodiment of the present invention.

Referring to FIGS. 16 to 19, the drying and post-curing module 400 dries and solidifies an output.

The drying and post-curing module 400 includes the drying and post-curing system 420 and the drying and post-curing transfer unit 410.

The drying and post-curing system 420 dries and solidifies the output.

The drying and post-curing system 420 includes a drying container 421, a fan heater 422, a light output unit 423, and a shielding system 424.

The drying container 421 dries the output transferred from the second cleaning module 300 and containing a large amount of the second cleaning solution.

A drying and post-curing cover (not shown) may be installed in the drying container 421. The drying and post-curing cover lowers to an upper portion of the drying container 421 to prevent heat from leaking to the outside.

The fan heater 422 is installed to pass through a central portion of the drying and post-curing cover to generate high-temperature and high-pressure hot air.

The light output unit 423 is disposed on each of four side surfaces and a bottom surface of the drying container 421 and outputs light with the same wavelength (in an ultraviolet region) used in the 3D printer 10. The light output unit 423 may include a plurality of light-emitting diode (LED) light sources and a control printed circuit board (PCB) for controlling the LED light sources.

The shielding system 424 blocks ultraviolet rays generated when the drying and post-curing module 400 operates to protect workers from ultraviolet rays.

The drying and post-curing transfer unit 410 vertically or horizontally transfers the basket 20.

The drying and post-curing transfer unit 410 includes the drying and post-curing horizontal transfer system 412, a drying and post-curing vertical transfer system 413, the drying and post-curing circular stage 414, the drying and post-curing horizontal position detector 415, a drying and post-curing vertical position detector 416, and the post-curing rotation position detector 418.

The drying and post-curing horizontal transfer system 412 horizontally transfers the basket 20. The drying and post-curing horizontal transfer system 412 may include any type of compact transfer system that may be mounted within a range of an individual module such as a conveyor, a rail, or a linear stage.

The drying and post-curing vertical transfer system 413 vertically transports the basket 20 and the conveyor.

The drying and post-curing circular stage 414 horizontally rotates the basket 20, the drying and post-curing horizontal transfer system 412, and the drying and post-curing vertical transfer system 413. The drying and post-curing circular stage 414 may rotate the basket 20, the drying and post-curing horizontal transfer system 412, and the drying and post-curing vertical transfer system 413 360 degrees.

The drying and post-curing horizontal position detector 415 detects the position of the basket 20 in a horizontal direction. The drying and post-curing horizontal position detector 415 includes a first drying and post-curing horizontal position sensor 415a installed at one end portion of the drying and post-curing horizontal transfer system 412 to detect the position of the basket 20, a third drying and post-curing horizontal position sensor 415c installed at the other end portion of the drying and post-curing horizontal transfer system 412 to detect the position of the basket 20, and a second drying and post-curing horizontal position sensor 415b installed at a central portion of the drying and post-curing horizontal transfer system 412 to detect the position of the basket 20. The number and installation positions of sensors of the drying and post-curing horizontal position detector 415 are not particularly limited.

The drying and post-curing vertical position detector 416 detects the position of the basket 20 in a vertical direction. The drying and post-curing vertical position detector 416 includes a first drying and post-curing vertical position sensor 416a installed at one end portion of the drying and post-curing vertical transfer system 413 to detect the basket 20, and a second drying and post-curing vertical position sensor 416b installed at the other end portion of the drying and post-curing vertical transfer system 413 to detect the basket 20. The number and installation positions of sensors of the drying and post-curing vertical position detector 416 are not particularly limited.

The drying and post-curing rotation position detector 418 detects the rotation position of the drying and post-curing circular stage 414. For example, the drying and post-curing rotation position detector 418 is installed in the drying and post-curing circular stage 414 at each of angles of 0 degrees, 45 degrees, 90 degrees, 270 degrees, and 350 degrees to detect the drying and post-curing circular stage 414. The installation positions, angles, and number of sensors of the drying and post-curing circular stage 414 are not particularly limited.

The operation process of the drying and post-curing module 400 is as follows.

When the basket 20 is transferred from the second cleaning module 300, and the first drying and post-curing horizontal position sensor 415a recognizes the basket 20, the drying and post-curing horizontal transfer system 412 operates.

When the drying and post-curing horizontal transfer system 412 transfers the basket 20, the first drying and post-curing horizontal position sensor 415a turns off, and the second drying and post-curing horizontal position sensor 415b recognizes the basket 20. In this case, the drying and post-curing horizontal transfer system 412 stops.

While the drying and post-curing vertical transfer system 413 vertically lowers and transfers the basket 20, the first drying and post-curing vertical position sensor 416a is turned off, and when the second drying and post-curing horizontal position sensor 415a recognizes the basket 20, the drying and post-curing vertical transfer system 413 stops.

In this case, the basket 20 containing an output is positioned in the drying container 421, and the fan heater 422 operates so that high-temperature hot air dries the output. The power and operation time of the fan heater 422 may be adjusted in various ways according to the size and volume of the output. In addition, when drying is completed, the light output unit 423 effectively post-cures the output by adjusting the intensity of light and an operating time in various ways according to the size and volume of the output for post-curing.

When a post-curing process is completed, while the drying and post-curing vertical transfer system 413 vertically lifts and transfers the basket 20, the second drying and post-curing vertical position sensor 416b is turned off, and when the first drying and post-curing horizontal position sensor 415a recognizes the basket 20, the drying and post-curing vertical transfer system 413 stops.

Additionally, while the drying and post-curing horizontal transfer system 412 further transfers the basket 20, the second drying and post-curing horizontal position sensor 415b is turned off, and when the third drying and post-curing horizontal position sensor 415c recognizes the basket 20, the drying and post-curing horizontal transfer system 412 stops. Thereafter, after a finally determined position is identified, the basket 20 containing the output subjected to a post-processing process is transferred.

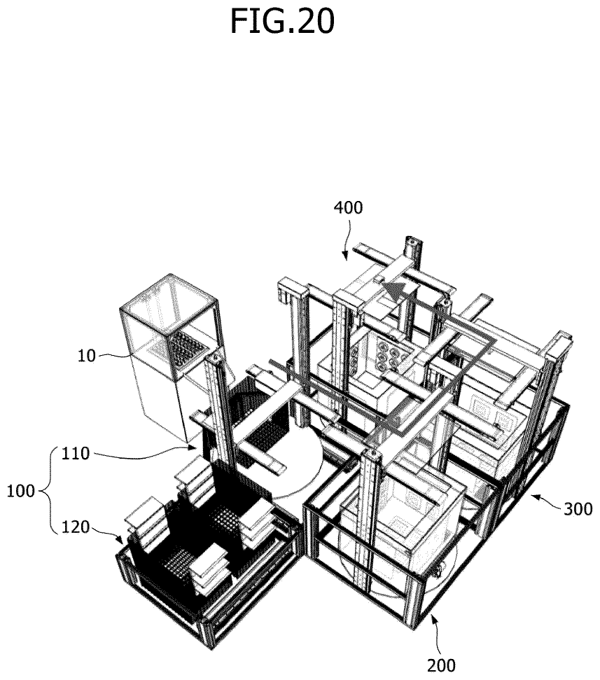

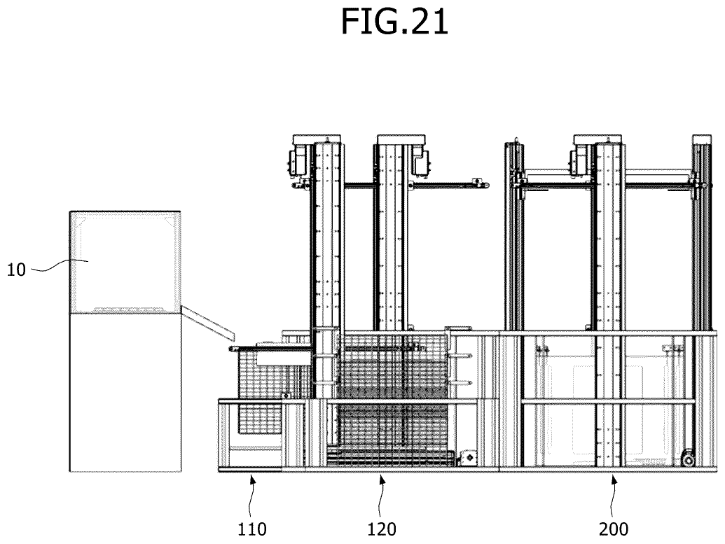

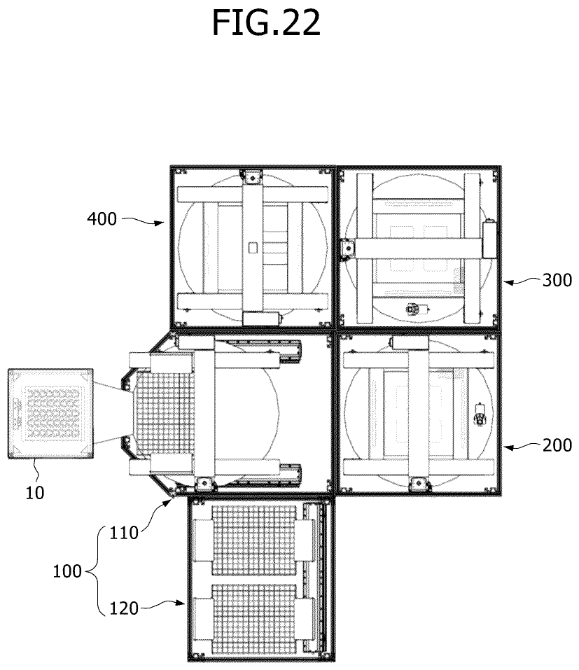

FIG. 20 is a view illustrating an example of an arrangement method of a 3D printer output post-processing apparatus according to one embodiment of the present invention. FIG. 21 is a side view of the 3D printer output post-processing apparatus shown in FIG. 20. FIG. 22 is a plan view of the 3D printer output post-processing apparatus shown in FIG. 20.

Referring to FIGS. 20 to 22, each process module may be independently separated to individually operate.

As described above, since each process module is equipped with a horizontal transfer system 112, 212, or 412 and a vertical transfer system 113, 213, or 313, the input/output of an output and a corresponding post-processing function may be independently performed. Therefore, if necessary, only one process module may operate to repeatedly process only a specific process.

Since each process module can be rotated up to 360 degrees through a circular stage 114, 214, or 314, the process modules may not necessarily be arranged in a series combination but may be arranged in a free form according to a spatial situation of an installation site so that spatial efficiency can be considerably improved.

Since each process module can be rotated, for example, 90 degrees by the circular stage 114, 214, or 314, a subsequent process module can be disposed in consideration of the possibility of arrangement according to an installation position so that space efficiency can be maximized.

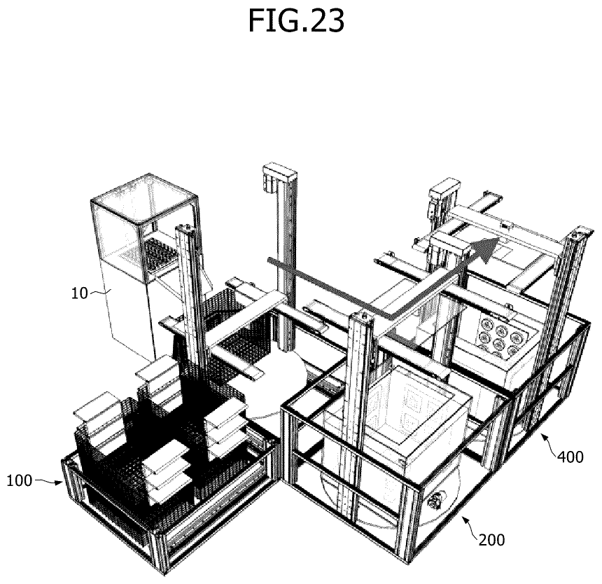

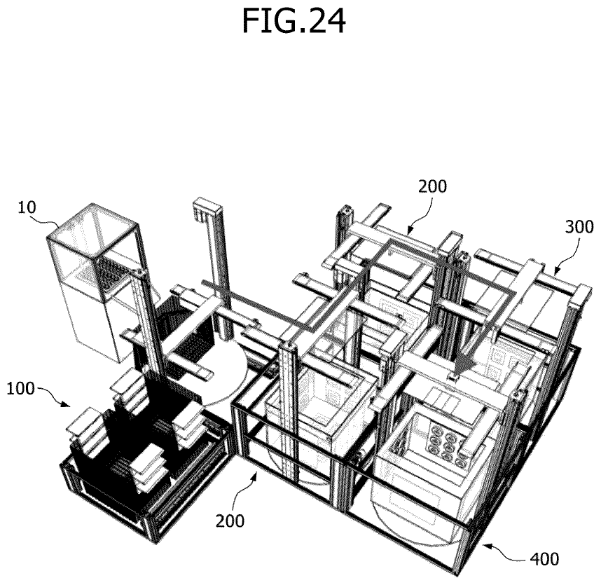

FIG. 23 is a view illustrating another example of an arrangement method of a 3D printer output post-processing apparatus according to one embodiment of the present invention. FIG. 24 is a view illustrating still another example of an arrangement method of a 3D printer output post-processing apparatus according to one embodiment of the present invention.

Referring to FIGS. 23 and 24, since each process module is independently separated, the process module may be optionally connected by adding or excluding a specific process from a basic process as needed.

For example, when cleaning is sufficiently completed only through a first cleaning process by a first cleaning module 200 due to the characteristics of an output, a second cleaning process is unnecessary. In this case, a supply module 100, a first cleaning module 200, and a drying and post-curing module 400 may be connected to complete a post-treatment process through a supply process, a first cleaning process, and a drying and post-curing process.

In addition, when a resin is not sufficiently removed even after a first cleaning process is performed once through the first cleaning module 200, one first cleaning module 200 may be further added to perform the first cleaning process twice. That is, a post-processing process may be completed through a supply process, a first cleaning process (once), a first cleaning process (twice), a second cleaning process, and a drying and post-curing process.

That is, all post-processing processes may be performed in a direction of an arrow by adding or subtracting the process module as needed.

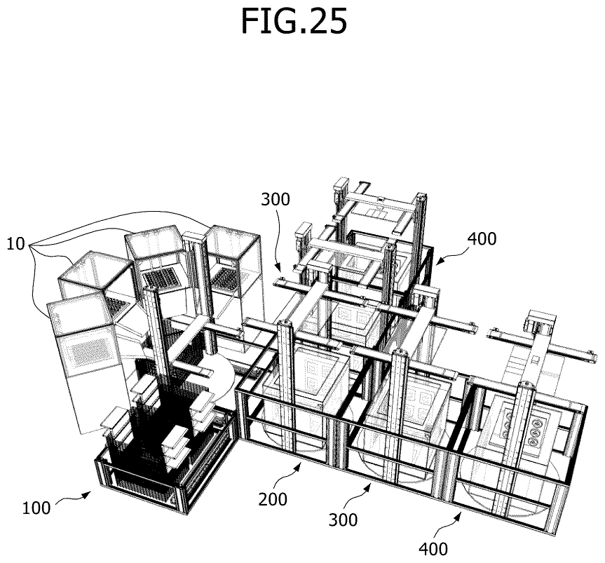

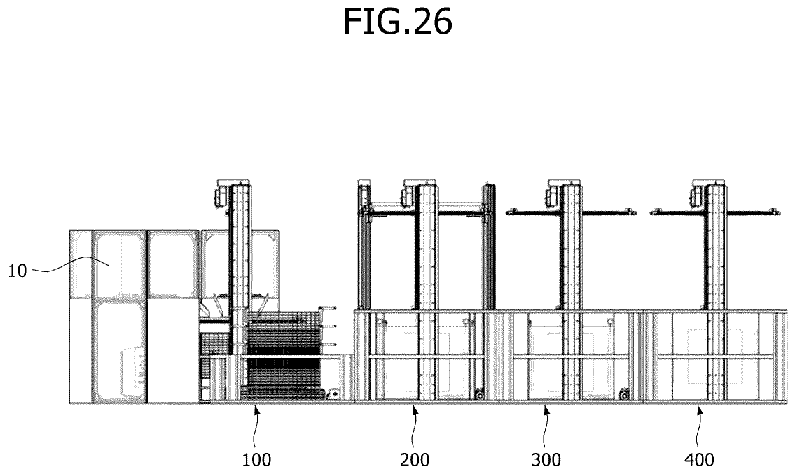

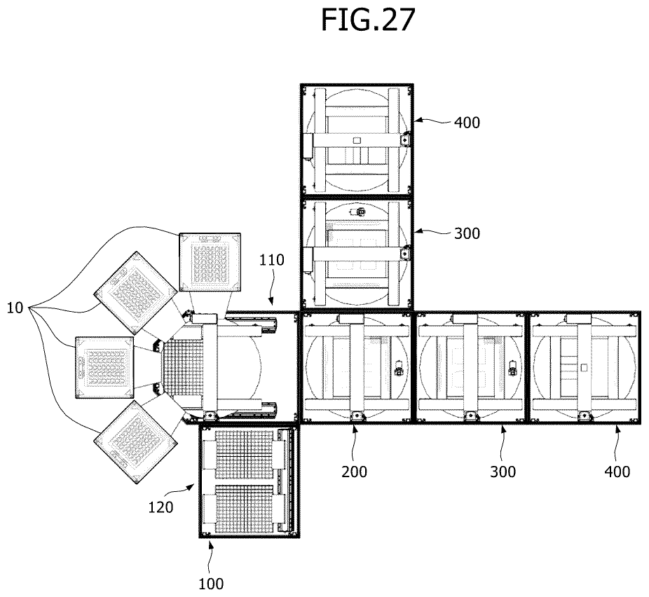

FIG. 25 is a view illustrating yet another example of an arrangement method of a 3D printer output post-processing apparatus according to one embodiment of the present invention. FIG. 26 is a side view of the 3D printer output post-processing apparatus shown in FIG. 21. FIG. 27 is a plan view of the 3D printer output post-processing apparatus shown in FIG. 21.

Referring to FIGS. 25 to 27, the 3D printer output post-processing apparatus according to one embodiment of the present invention may include a combination of a single 3D printer 10 and single process modules as a basic type as well as a combination of a plurality of 3D printers 10 and a plurality of process modules.

The process modules may adjust the timings of and supply various individually produced outputs from the plurality of 3D printers 10 to be output at different times, and thus post-processing such as process order and task assignment may be flexibly performed.

Parameter values of the process module can be set in various ways according to the characteristics of different outputs produced by each 3D printer 10, and the parameter values can be automatically input to the process modules to which a task is assigned.

Here, artificial intelligence (AI)-based post-processing process management software can centrally control task allocation and process line determination so that optimal processing can be realized based on a task state.

In a 3D printer output post-processing apparatus according to the present invention, each process module can be modularized, independently separated, and individually operated, and in particular, since each process module is equipped with a transfer unit in a horizontal or vertical direction, the input/output of an output and a corresponding post-processing function can be independently performed.

In a 3D printer output post-processing apparatus according to the present invention, since each process module is independently separated, the process modules can be optionally added or excluded to connect the process modules.

In a 3D printer output post-processing apparatus according to the present invention, since each process module can be rotated 360 degrees, the process modules can be arranged in a series combination and can also be arranged in a free form according to a spatial situation, thereby securing high spatial efficiency.

A 3D printer output post-processing apparatus according to the present invention can also include a combination of a plurality of 3D printers and a plurality of process modules. By using the combination of the plurality of 3D printers and the plurality of process modules, different outputs individually produced by the 3D printers can be flexibly post-processed in terms of time.

While the present invention has been described with reference to embodiments shown in the drawings, these should be considered in a descriptive sense only, and it will be understood by those skilled in the art that various alterations and other equivalent embodiments may be made. Accordingly, the technical protection scope of the present invention should be defined only by the appended claims.

What is claimed is:

1. A three-dimensional (3D) printer output post-processing apparatus comprising at least one of a supply module configured to receive an output from 3D printers, a first cleaning module configured to clean the output, a second cleaning module configured to clean the output, and a drying and post-curing module configured to dry and solidify the output,
wherein the supply module, the first cleaning module, the second cleaning module, and the drying and post-curing module are modularized so that at least one thereof is optionally combined.

2. The 3D printer output post-processing apparatus of claim 1, wherein the supply module includes a basket transfer unit configured to horizontally or vertically transfer a basket or rotate the basket, and a basket supply module configured to supply the basket to the basket transfer unit.

3. The 3D printer output post-processing apparatus of claim 2, wherein the basket transfer unit includes an output recognition sensor configured to recognize the output, a supply horizontal transfer system configured to horizontally transfer the basket, a supply vertical transfer system configured to vertically transfer the basket, a supply circular stage configured to horizontally rotate the basket, the supply horizontal transfer system, and the supply vertical transfer system, a supply horizontal position detector configured to detect a position of the basket in a horizontal direction, a supply vertical position detector configured to detect a position of the basket in a vertical direction, and a supply rotation position detector configured to detect a rotation position of the supply circular stage.

4. The 3D printer output post-processing apparatus of claim 1, wherein the first cleaning module includes a first cleaning system configured to clean the output using a first cleaning solution, and a first basket cleaning transfer unit configured to horizontally or vertically transfer the basket or rotate the basket.

5. The 3D printer output post-processing apparatus of claim 4, wherein the first cleaning system includes a cleaning container configured to store the first cleaning solution, a multi-nozzle system configured to generate high-pressure flow to a center from each side surface and a bottom of the cleaning container, and a first cleaning solution temperature maintenance system configured to maintain a temperature of the first cleaning solution in a first set temperature range.

6. The 3D printer output post-processing apparatus of claim 4, wherein the first basket cleaning transfer unit includes a first cleaning horizontal transfer system configured to horizontally transfer the basket, a first cleaning vertical transfer system configured to vertically transfer the basket, a first cleaning circular stage configured to horizontally rotate the basket, the first cleaning horizontal transfer system, and the first cleaning vertical transfer system, a first cleaning horizontal position detector configured to detect a position of the basket in a horizontal direction, a first cleaning vertical position detector configured to detect a position of the basket in a vertical direction, and a first cleaning rotation position detector configured to detect a rotation position of the first cleaning circular stage.

7. The 3D printer output post-processing apparatus of claim 1, wherein the second cleaning module includes a second cleaning system configured to clean the output using a second cleaning solution, and a second basket cleaning transfer unit configured to horizontally or vertically transfer a basket or rotate the basket.

8. The 3D printer output post-processing apparatus of claim 7, wherein the second cleaning system includes a cleaning container configured to store the second cleaning solution, a multi-nozzle system configured to generate high-pressure flow to a center from each side surface and a bottom of the cleaning container, and a second cleaning solution temperature maintenance system configured to maintain a temperature of the second cleaning solution in a second set temperature range.

9. The 3D printer output post-processing apparatus of claim 7, wherein the second basket cleaning transfer unit includes a second cleaning horizontal transfer system configured to horizontally transfer the basket, a second cleaning vertical transfer system configured to vertically transfer the basket, a second cleaning circular stage configured to horizontally rotate the basket, the second cleaning horizontal transfer system, and the second cleaning vertical transfer system, a second cleaning horizontal position detector configured to detect a position of the basket in a horizontal direction, a second cleaning vertical position detector configured to detect a position of the basket in a vertical direction, and a second cleaning rotation position detector configured to detect a rotation position of the second cleaning circular stage.

10. The 3D printer output post-processing apparatus of claim 1, wherein the drying and post-curing module includes a drying and post-curing system configured to dry and solidify the output, and a drying and post-curing transfer unit configured to horizontally or vertically transfer the basket or rotate the basket.

11. The 3D printer output post-processing apparatus of claim 1, wherein the drying and post-curing system includes a drying container configured to accommodate the basket, and a fan heater configured to send hot air into the drying container.

12. The 3D printer output post-processing apparatus of claim 10, wherein the drying and post-curing transfer unit includes a drying and post-curing horizontal transfer system configured to horizontally transfer the basket, a drying and post-curing vertical transfer system configured to vertically transfer the basket, a drying and post-curing circular stage configured to horizontally rotate the basket, the drying and post-curing horizontal transfer system, and the drying and post-curing vertical transfer system, a drying and post-curing horizontal position detector configured to detect a position of the basket in a horizontal direction, a drying and post-curing vertical position detector configured to detect a position of the basket in a vertical direction, and a drying and post-curing rotation position detector configured to detect a rotation position of the drying and post-curing circular stage.

13. The 3D printer output post-processing apparatus of claim 1, wherein at least one of the first cleaning module, the second cleaning module, and the drying and post-curing module is installed in plural.

14. The 3D printer output post-processing apparatus of claim 1, wherein at least one of the supply module, the first cleaning module, the second cleaning module, and the drying and post-curing module is connected in at least one direction.

15. The 3D printer output post-processing apparatus of claim 1, wherein the supply module is optionally connected to at least one of the 3D printers to receive the output from any one of the printers.

16. A three-dimensional (3D) printer output post-processing apparatus comprising:
a supply module configured to receive an output manufactured by 3D printers;
a first cleaning module configured to receive the output from the supply module and clean the output;
a second cleaning module configured to clean the output cleaned in the first cleaning module; and
a drying and post-curing module configured to dry and solidify the output cleaned in the second cleaning module.

17. The 3D printer output post-processing apparatus of claim 16, wherein the supply module includes a basket transfer module configured to supply a basket configured to receive and transfer the output, and a basket supply unit configured to horizontally or vertically transfer the basket or rotate the basket.

18. The 3D printer output post-processing apparatus of claim 16, wherein the first cleaning module includes a first cleaning system configured to clean the output using a first cleaning solution, and a first basket cleaning transfer unit configured to horizontally or vertically transfer a basket or rotate the basket.

19. The 3D printer output post-processing apparatus of claim 16, wherein the second cleaning module includes a second cleaning system configured to clean the output using a second cleaning solution, and a second basket cleaning transfer unit configured to horizontally or vertically transfer a basket or rotate the basket.

20. The 3D printer output post-processing apparatus of claim 16, wherein the drying and post-curing module includes a drying and post-curing system configured to dry and solidify the output, and a drying and post-curing transfer unit configured to horizontally or vertically transfer a basket or rotate the basket.
